(19) United States
(12) Patent Application Publication
(10) Pub. No.: US 2010/0052454 A1
(43) Pub. Date: Mar. 4, 2010

(54) Actuating Device for a Motorized Wheeled Vehicle with an Electric Generating Function

(76) Inventor: Wei-Ting Lin, Taichung City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/436,908

(22) Filed: May 7, 2009

(30) Foreign Application Priority Data
Aug. 29, 2008 (TW) 097215569

(51) Int. Cl. H02K 1/27

(52) U.S. Cl. 310/156.08

(57) ABSTRACT

An actuating device for a motorized bicycle includes a fixed unit and a rotation unit. The fixed unit includes a mandrel and a plurality of coils. The rotation unit includes a rotation member and a plurality of magnets. Each of the magnets is inclined relative to a respective one of the coils so that each of the magnets is closer to any two adjacent coils to promote the magnetic interaction between each of the magnets and any two adjacent coils so as to enhance the rotation efficiency of the rotation unit. When the bicycle is padelled by a rider or traveled on a downward slope, the actuating device has a generating function to produce an electric current so as to replenish the electric power of the bicycle.

### BACKGROUND OF THE INVENTION

1. Field of the Invention

The present invention relates to an actuating device and, more particularly, to an actuating device for a motorized wheeled vehicle, such as a motorized bicycle and the like.

2. Description of the Related Art

A conventional motorized bicycle comprises a storage battery which supplies an electric power to rotate a front wheel or rear wheel so as to move the bicycle forward automatically without needing padelling of a rider so as to save the rider's energy. However, the electric power supplied by the storage battery is limited so that the storage battery cannot be used to satisfy the larger power requirement of the bicycle during a long period of time, thereby limiting movement of the bicycle.

### BRIEF SUMMARY OF THE INVENTION

In accordance with the present invention, there is provided an actuating device, comprising a fixed unit and a rotation unit rotatably mounted on the fixed unit. The fixed unit includes a mandrel and a plurality of coils mounted on the mandrel and arranged in a radiating manner. The rotation unit includes an annular rotation member rotatably mounted on the mandrel of the fixed unit and surrounding the coils of the fixed unit and a plurality of magnets mounted in the rotation member to move in concert with the rotation member and movable to pass the coils of the fixed unit. Each of the coils of the fixed unit is directed in a radial direction that extends radially and outwardly from the mandrel. Each of the magnets of the rotation unit is parallel with the mandrel of the fixed unit. Each of the magnets of the rotation unit is inclined relative to a respective one of the coils of the fixed unit so that an angle is defined between each of the magnets of the rotation unit and the radial direction of the respective coil of the fixed unit.

The primary objective of the present invention is to provide an actuating device for a motorized wheeled vehicle with an electric generating function.

Another objective of the present invention is to provide an actuating device that is changeable between a motor and a generator.

A further objective of the present invention is to provide an actuating device, wherein when the bicycle is padelled by a rider or traveled on a downward slope, the actuating device has a generating function to produce an electric current which is delivered to the battery of the bicycle so as to replenish the electric power of the bicycle.

A further objective of the present invention is to provide an actuating device, wherein each of the magnets of the rotation unit is inclined relative to a respective one of the coils of the fixed unit, so that each of the magnets is closer to any two adjacent coils to promote the magnetic interaction between each of the magnets and any two adjacent coils so as to accelerate the rotation speed and to enhance the rotation efficiency of the rotation unit.

A further objective of the present invention is to provide an actuating device, wherein each of the magnets consisting of neodymium, iron and boron has a stronger magnetic force and is not easily aged during a long-term utilization.

A further objective of the present invention is to provide an actuating device, wherein each of the magnetically conductive plates has a high magnetic conductivity and a high heat radiating efficiency.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of an actuating device in accordance with the preferred embodiment of the present invention.

FIG. 2 is an exploded perspective view of the actuating device as shown in FIG. 1.

FIG. 3 is a side cross-sectional view of the actuating device as shown in FIG. 1.

FIG. 4 is a front broken view of the actuating device as shown in FIG. 1.

FIG. 5 is a side view of the actuating device for a bicycle in accordance with the preferred embodiment of the present invention.

### DETAILED DESCRIPTION OF THE INVENTION

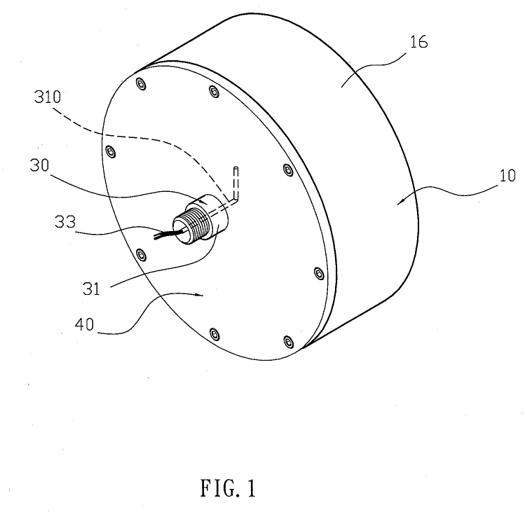

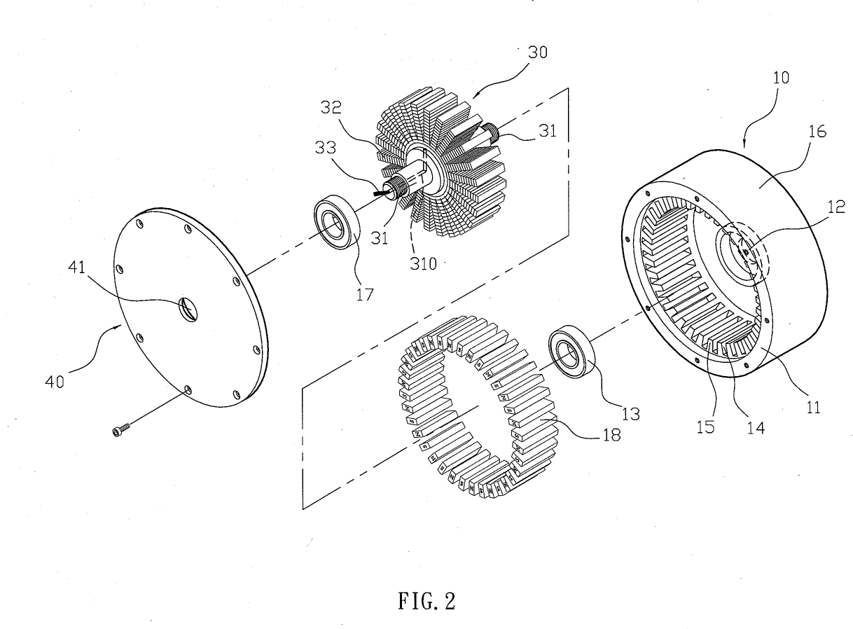

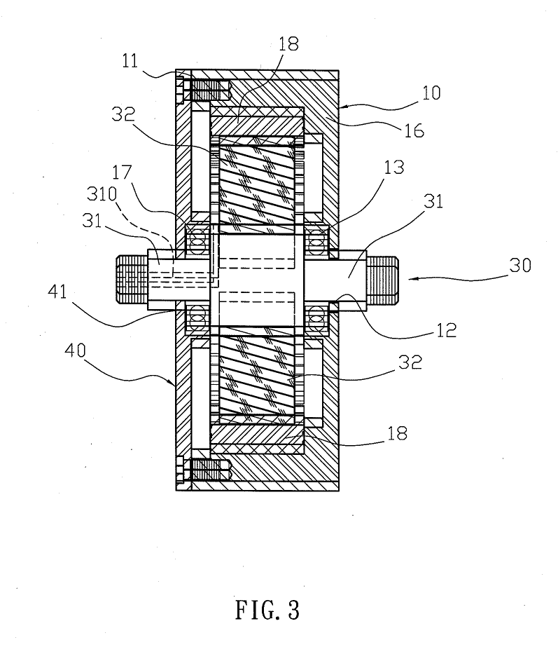

Referring to the drawings and initially to FIGS. 1-4, an actuating device for a motorized bicycle in accordance with the preferred embodiment of the present invention comprises a fixed unit 30, a rotation unit 10 rotatably mounted on the fixed unit 30, and an outer cover 40 mounted on the rotation unit 10 to cover the fixed unit 30.

The fixed unit 30 includes a mandrel 31, a plurality of coils 32 mounted on the mandrel 31 and arranged in a radiating manner, and an electric wire 33 electrically connected to each of the coils 32 to supply an electric power to each of the coils 32. The mandrel 31 of the fixed unit 30 has an inner portion provided with a channel 310 to allow passage of the electric wire 33. Each of the coils 32 of the fixed unit 30 is directed in a radial direction that extends radially and outwardly from the mandrel 31. In the preferred embodiment of the present invention, the fixed unit 30 includes twenty-four coils 32.

The rotation unit 10 includes an annular rotation member 16 rotatably mounted on the mandrel 31 of the fixed unit 30 and surrounding the coils 32 of the fixed unit 30, a plurality of magnets 18 mounted in the rotation member 16 to move in concert with the rotation member 16 and movable to pass the coils 32 of the fixed unit 30, a first bearing 13 mounted in the rotation member 16 and located between the rotation member 16 and a first end of the mandrel 31, and a second bearing 17 mounted in the outer cover 40 and located between the outer cover 40 and a second end of the mandrel 31.

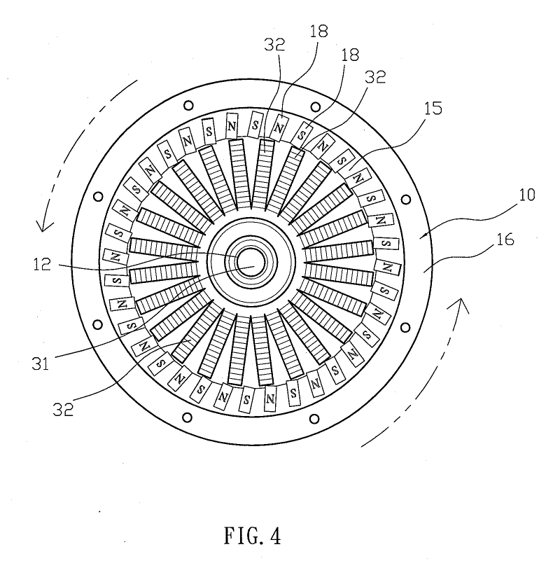

Each of the magnets 18 of the rotation unit 10 is parallel with the mandrel 31 of the fixed unit 30. Each of the magnets 18 of the rotation unit 10 is inclined relative to a respective one of the coils 32 of the fixed unit 30 so that an angle is defined between each of the magnets 18 of the rotation unit 10 and the radial direction of the respective coil 32 of the fixed unit 30. Each of the magnets 18 of the rotation unit 10 is an elongate bar-shaped permanent magnet and is a compound consisting of neodymium (Nd) of 32%, iron (Fe) of 64% and boron (B) of 4%. In practice, any two adjacent magnets 18 have different magnetic poles, that is, when one of the magnets 18 has a north (N) pole, an adjacent magnet 18 has a south (S) pole, so that the north (N) poles and the south (S) poles of the magnets 18 are arranged in a staggered manner as shown in FIG. 4.

The rotation member 16 of the rotation unit 10 has a substantially cylindrical shape. The rotation member 16 of the rotation unit 10 has a first side rotatably mounted on the first bearing 13 and having a central portion provided with a stepped shaft hole 12 to allow passage of the first end of the mandrel 31 and to receive the first bearing 13. The rotation member 16 of the rotation unit 10 has a second side provided with an open mounting face 11 for mounting the outer cover 40. The rotation member 16 of the rotation unit 10 is centered at the mandrel 31 of the fixed unit 30. The rotation member 16 of the rotation unit 10 has an inner wall provided with a plurality of axially extending retaining grooves 14 to receive the magnets 18 respectively. The inner wall of the rotation member 16 is further provided with a plurality of axially extending magnetically conductive plates 15 located between the retaining grooves 14 respectively to conserve the magnetic forces of the magnets 18 respectively. In the preferred embodiment of the present invention, the rotation unit 10 includes thirty-six retaining grooves 14 and thirty-six magnets 18.

The magnetically conductive plates 15 and the retaining grooves 14 of the rotation member 16 are arranged in a staggered manner, and the magnetically conductive plates 15 of the rotation member 16 and the magnets 18 are also arranged in a staggered manner. Thus, each of the magnets 18 is located between any adjacent two of the magnetically conductive plates 15. In such a manner, the coils 32 of the fixed unit 30 are not in contact with the magnets 18 and the magnetically conductive plates 15.

Each of the retaining grooves 14 of the rotation member 16 is parallel with the mandrel 31 of the fixed unit 30. Each of the retaining grooves 14 of the rotation member 16 is inclined relative to a respective one of the coils 32 of the fixed unit 30 so that an angle is defined between each of the retaining grooves 14 of the rotation member 16 and the radial direction of the respective coil 32 of the fixed unit 30. Each of the magnetically conductive plates 15 of the rotation member 16 is parallel with the mandrel 31 of the fixed unit 30. Each of the magnetically conductive plates 15 of the rotation member 16 is inclined relative to a respective one of the coils 32 of the fixed unit 30 so that an angle is defined between each of the magnetically conductive plates 15 of the rotation member 16 and the radial direction of the respective coil 32 of the fixed unit 30. Each of the magnetically conductive plates 15 of the rotation member 16 is a nickel-based plate.

The outer cover 40 is rotatably mounted on the second bearing 17 and has a central portion provided with a stepped shaft bore 41 to allow passage of the second end of the mandrel 31 and to receive the second bearing 17.

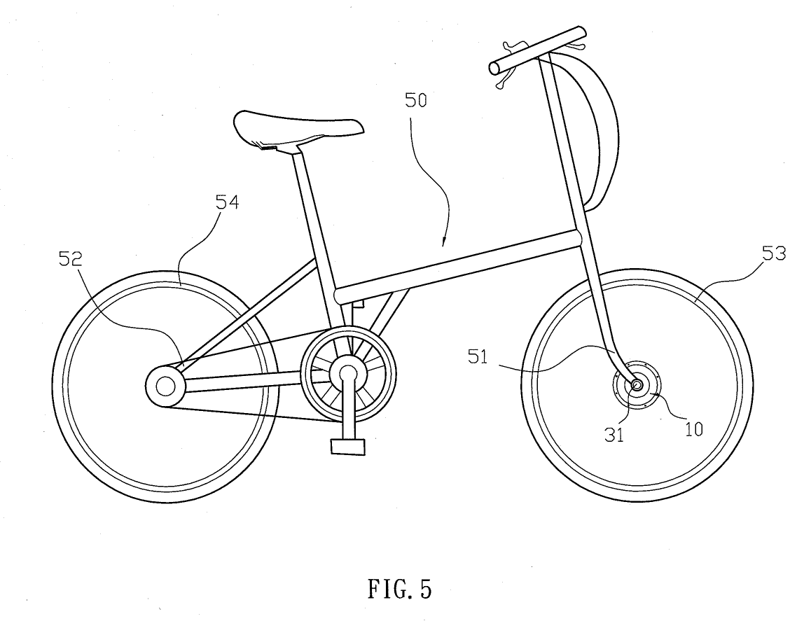

In operation, referring to FIG. 5 with reference to FIGS. 1-4, when the actuating device is mounted on a bicycle 50, the mandrel 31 of the fixed unit 30 is mounted on a front fork 51 (or a seat stay 52) of the bicycle 50, the rotation member 16 of the rotation unit 10 is mounted in a front wheel 53 (or a rear wheel 54) of the bicycle 50, and the electric wire 33 of the fixed unit 30 is electrically connected to a battery (not shown) of the bicycle 50 to supply an electric current to each of the coils 32 of the fixed unit 30. The bicycle 50 has a controller (not shown) to control and change the current direction of each of the coils 32.

In practice, when the electric current from the battery of the bicycle 50 is delivered through the electric wire 33 to each of the coils 32, each of the coils 32 produces a magnetic field, and the magnetic lines of each of the coils 32 is directed in a radial direction that extends radially and outwardly from the mandrel 31. At this time, any two adjacent coils 32 have different current directions, so that any two adjacent coils 32 have different magnetic poles. That is, when one of the coils 32 has a north (N) pole, an adjacent coil 32 has a south (S) pole, so that the north (N) poles and the south (S) poles of the coils 32 are arranged in a staggered manner.

In such a manner, when one magnet 18 having a north (N) pole aligns with the respective coil 32 having a north (N) pole, the magnet 18 having a north (N) pole is repelled by the respective coil 32 having a north (N) pole and is attracted by an adjacent coil 32 having a south (S) pole, so that the magnet 18 having a north (N) pole is moved forward by actions of the two coils 32. Then, when the magnet 18 having a north (N) pole aligns with the respective coil 32 having a south (S) pole, the current direction of each of the coils 32 is reversed instantaneously to change the magnetic pole of each of the coils 32, so that the respective coil 32 is changed to have a north (N) pole, and an adjacent coil 32 is changed to have a south (S) pole. Thus, the magnet 18 having a north (N) pole is repelled by the respective coil 32 having a north (N) pole and is attracted by an adjacent coil 32 having a south (S) pole, so that the magnet 18 having a north (N) pole is moved forward again by actions of the two coils 32. Therefore, the magnetic pole of each of the coils 32 is changed successively to move each of the magnets 18 so that the rotation member 16 of the rotation unit 10 is driven by the magnets 18 to rotate relative to the mandrel 31 so as to rotate the front wheel 53 and to the bicycle 50 forward.

On the contrary, when the bicycle 50 is padelled by a rider or traveled on a downward slope, the electric current from the battery of the bicycle 50 to each of the coils 32 is stopped. In such a manner, the rotation member 16 of the rotation unit 10 is driven by the front wheel 53 to rotate relative to the mandrel 31, so that the magnets 18 are rotated relative to the coils 32 to produce a magnetic interaction between the magnets 18 and the coils 32 so as to produce an electric current which is delivered through the electric wire 33 to the battery of the bicycle 50.

Accordingly, when the bicycle 50 is padelled by a rider or traveled on a downward slope, the actuating device has a generating function to produce an electric current which is delivered to the battery of the bicycle 50 so as to replenish the electric power of the bicycle 50. In addition, each of the magnets 18 of the rotation unit 10 is inclined relative to a respective one of the coils 32 of the fixed unit 30, so that each of the magnets 18 is closer to any two adjacent coils 32 to promote the magnetic interaction between each of the magnets 18 and any two adjacent coils 32 so as to accelerate the rotation speed and to enhance the rotation efficiency of the rotation unit 10. Further, each of the magnets 18 consisting of neodymium, iron and boron has a stronger magnetic force and is not easily aged during a long-term utilization. Further, each of the magnetically conductive plates 15 has a high magnetic conductivity and a high heat radiating efficiency.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. An actuating device, comprising:
a fixed unit;
a rotation unit rotatably mounted on the fixed unit; wherein:
the fixed unit includes:
a mandrel;
a plurality of coils mounted on the mandrel and arranged in a radiating manner;
the rotation unit includes:
an annular rotation member rotatably mounted on the mandrel of the fixed unit and surrounding the coils of the fixed unit;
a plurality of magnets mounted in the rotation member to move in concert with the rotation member and movable to pass the coils of the fixed unit.

2. The actuating device of claim 1, wherein each of the magnets of the rotation unit is parallel with the mandrel of the fixed unit.

3. The actuating device of claim 2, wherein
each of the coils of the fixed unit is directed in a radial direction that extends radially and outwardly from the mandrel;
each of the magnets of the rotation unit is inclined relative to a respective one of the coils of the fixed unit;
an angle is defined between each of the magnets of the rotation unit and the radial direction of the respective coil of the fixed unit.

4. The actuating device of claim 1, wherein
any two adjacent magnets have different magnetic poles;
the magnetic poles of the magnets are arranged in a staggered manner.

5. The actuating device of claim 1, wherein each of the magnets of the rotation unit is an elongate bar-shaped permanent magnet.

6. The actuating device of claim 5, wherein each of the magnets of the rotation unit is a compound consisting of neodymium (Nd) of 32%, iron (Fe) of 64% and boron (B) of 4%.

7. The actuating device of claim 1, wherein the rotation member of the rotation unit has an inner wall provided with a plurality of axially extending retaining grooves to receive the magnets respectively.

8. The actuating device of claim 7, wherein the inner wall of the rotation member is further provided with a plurality of axially extending magnetically conductive plates located between the retaining grooves respectively.

9. The actuating device of claim 8, wherein
the magnetically conductive plates and the retaining grooves of the rotation member are arranged in a staggered manner;
the magnetically conductive plates of the rotation member and the magnets are arranged in a staggered manner;
each of the magnets is located between any adjacent two of the magnetically conductive plates.

10. The actuating device of claim 9, wherein the coils of the fixed unit are non-contactable not in contact with the magnets and the magnetically conductive plates.

11. The actuating device of claim 8, wherein
each of the retaining grooves of the rotation member is parallel with the mandrel of the fixed unit;
each of the retaining grooves of the rotation member is inclined relative to a respective one of the coils of the fixed unit;
an angle is defined between each of the retaining grooves of the rotation member and the radial direction of the respective coil of the fixed unit.

12. The actuating device of claim 11, wherein
each of the magnetically conductive plates of the rotation member is parallel with the mandrel of the fixed unit;
each of the magnetically conductive plates of the rotation member is inclined relative to a respective one of the coils of the fixed unit;
an angle is defined between each of the magnetically conductive plates of the rotation member and the radial direction of the respective coil of the fixed unit.

13. The actuating device of claim 8, wherein each of the magnetically conductive plates of the rotation member is a nickel-based plate.

14. The actuating device of claim 1, wherein the rotation member of the rotation unit is centered at the mandrel of the fixed unit.

15. The actuating device of claim 1, further comprising:
an outer cover mounted on the rotation unit to cover the fixed unit.

16. The actuating device of claim 15, wherein the rotation unit further includes:
a first bearing mounted in the rotation member and located between the rotation member and a first end of the mandrel;
a second bearing mounted in the outer cover and located between the outer cover and a second end of the mandrel.

17. The actuating device of claim 16, wherein
the rotation member of the rotation unit has a first side rotatably mounted on the first bearing and having a central portion provided with a stepped shaft hole to allow passage of the first end of the mandrel and to receive the first bearing;
the rotation member of the rotation unit has a second side provided with an open mounting face for mounting the outer cover;
the outer cover is rotatably mounted on the second bearing and has a central portion provided with a stepped shaft bore to allow passage of the second end of the mandrel and to receive the second bearing.

18. The actuating device of claim 4, wherein
any two adjacent coils have different magnetic poles;
the magnetic poles of the coils are arranged in a staggered manner.

19. The actuating device of claim 1, wherein
the fixed unit further includes an electric wire electrically connected to each of the coils to supply an electric power to each of the coils;
the mandrel of the fixed unit has an inner portion provided with a channel to allow passage of the electric wire.

20. The actuating device of claim 1, wherein the rotation member of the rotation unit has a substantially cylindrical shape.
